(19) United States
(12) Patent Application Publication
(10) Pub. No.: US 2008/0314059 A1
(43) Pub. Date: Dec. 25, 2008

(54) DOUBLE CLUTCH DRIVE SYSTEM

(75) Inventors: Jeffrey G. Harkness, Montgomery, MN (US); Bruce McClellan, Bloomington, MN (US)

Correspondence Address: MICHAEL BEST & FRIEDRICH LLP, 100 E WISCONSIN AVENUE, Suite 3300, MILWAUKEE, WI, 53202, US

(73) Assignee: THERMO KING CORPORATION, Minneapolis, MN (US)

(21) Appl. No.: 11/765,513

(22) Filed: Jun. 20, 2007

(51) Int. Cl. F25B 27/00; B62D 53/06

(52) U.S. Cl. 62/236; 280/423.1

(57) ABSTRACT

A double clutch system that allows the engine to drive the compressor of an OEM system through a first engaged clutch when the engine is running and allows an electric motor to drive the compressor through a second engaged clutch when the engine is not running. The electric motor is powered by either a power source external to the tractor's engine compartment (e.g., a electric outlet or an auxiliary power unit having a diesel-fired engine and a generator) or powered by the tractor battery, which is charged by a power source external to the tractor's engine compartment.

### BACKGROUND

The present invention relates to a double clutch drive system, and more specifically, to a double clutch drive system for a tractor unit air conditioning system.

Known tractors of tractor and trailer units utilize standard OEM air conditioning systems that include a compressor that is driven from the tractor engine when the engine is running and the tractor is being driven. The compressor of a refrigerant circuit compresses a refrigerant that is routed to an evaporator that removes heat from an air stream directed into a passenger compartment of the tractor to control the temperature within the passenger compartment. The air conditioning controls and condenser and evaporator fans are powered by the tractor battery. When the tractor is parked, the engine must continue to run in order to provide the necessary power for the air conditioning system to function.

To improve efficiency while the tractor is parked, auxiliary power units (APUs) have been used to provide the air conditioning function separate from the OEM air conditioning system. When parked, the tractor engine can be stopped and a much smaller and more efficient diesel-fueled engine of the APU drives a separate compressor that is part of a separate refrigerant circuit that is used to control the temperature within the passenger compartment. The APU is more efficient than using the tractor engine to drive the OEM air conditioning system and the APU also runs much quieter. Despite these advantages, this alternative requires a duplicative refrigeration circuit that adds expense.

### SUMMARY

The present invention allows the efficient use of the OEM air conditioning system to control the air temperature of a tractor when the tractor is parked and the engine is not running. This is accomplished by providing a double clutch system that allows the engine to drive the compressor of the OEM system through a first engaged clutch when the engine is running and allows an electric motor to drive the compressor through a second engaged clutch when the engine is not running. The electric motor, the air conditioning system controls, and the evaporator and condenser fans are powered by either a power source external to the tractor's engine compartment (e.g., a electric outlet or an auxiliary power unit having a diesel-fueled engine and a generator) or powered by the tractor battery, which is charged by a power source external to the tractor's engine compartment.

In one embodiment, the invention provides a tractor unit for pulling a trailer unit. The tractor unit includes a frame, a passenger compartment supported by the frame, an engine compartment supported by the frame, an engine disposed within the engine compartment, a battery supported by the frame, and an electric motor supported by the frame. The tractor unit also includes a refrigerant circuit including a compressor operable to compress a refrigerant. The refrigerant circuit also includes an evaporator operable to allow the refrigerant to absorb heat from an air stream directed into the passenger compartment to cool the passenger compartment. The tractor unit also includes first and second clutches. The first clutch is coupled between the engine and the compressor and is operable to selectively engage to drive the compressor with an engine of the tractor unit when the engine is running. The second clutch is coupled between the electric motor and the compressor and is operable to selectively engage to drive the compressor with the electric motor when the engine is not running. Only one of the first and second clutches is engaged to operate the compressor when the engine is one of running and not running. When the second clutch is engaged the electric motor is powered by either a power source external to the engine compartment or the battery in electrical communication with a power source external to the engine compartment.

In another embodiment, the invention provides an air conditioning system for a tractor unit used to pull a trailer unit The air conditioning system includes an electric motor, a refrigerant circuit, and first and second clutches. The refrigerant circuit includes a compressor operable to compress a refrigerant and an evaporator operable to allow the refrigerant to absorb heat from an air stream directed into the passenger compartment to cool the passenger compartment. The first clutch selectively engages to drive the compressor with the engine when the engine is running. The second clutch is coupled between the electric motor and the compressor. The second clutch selectively engages to drive the compressor with the electric motor when the engine is not running. Only one of the first and second clutches is engaged to operate the compressor when the engine is one of running and not running. When the second clutch is engaged the electric motor is powered by either a power source external to the engine compartment or the battery in electrical communication with a power source external to the engine compartment.

In another embodiment, the invention is directed to a method of operating an air conditioning system for a tractor unit used to pull a trailer unit. The method includes compressing a refrigerant in a refrigeration circuit with a compressor, absorbing heat from an air stream with the refrigerant in an evaporator, directing the air stream into a passenger compartment of a tractor unit to cool the passenger compartment, engaging a first clutch, driving the compressor through the first engaged clutch with an engine of the tractor unit when the engine is running, engaging a second clutch and disengaging the first clutch, driving the compressor through the second engaged clutch with an electric motor of the tractor unit when the engine is not running, and powering the electric motor when the second clutch is engaged by either a power source external to the engine compartment or the battery in electrical communication with a power source external to the engine compartment.

Other aspects of the invention will become apparent by consideration of the detailed description and accompanying drawings.

### BRIEF DESCRIPTION OF THE DRAWINGS

FIG. 1 is a perspective view of a tractor and trailer unit according to one embodiment of the present invention.

FIG. 2 is a schematic view of an air conditioning system of the tractor and trailer unit of FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

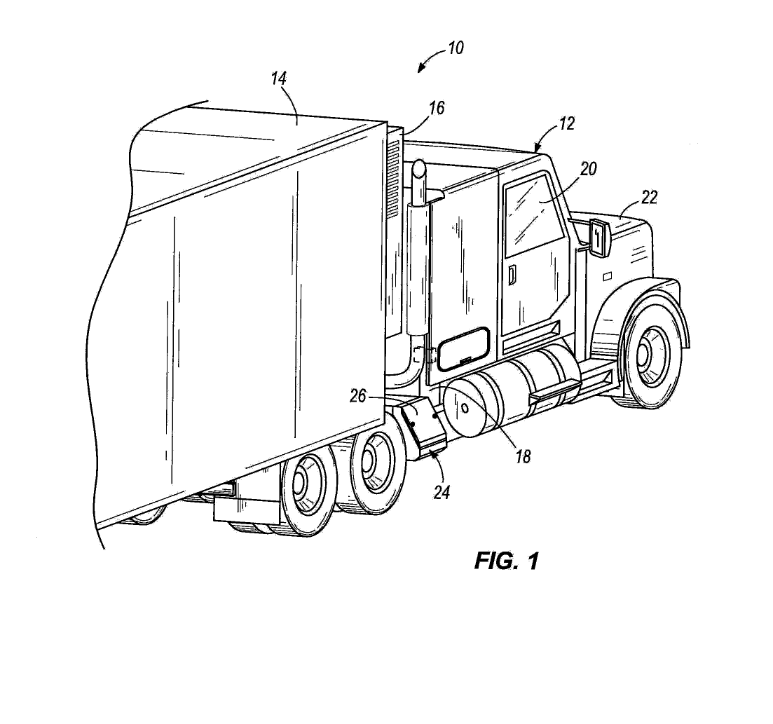

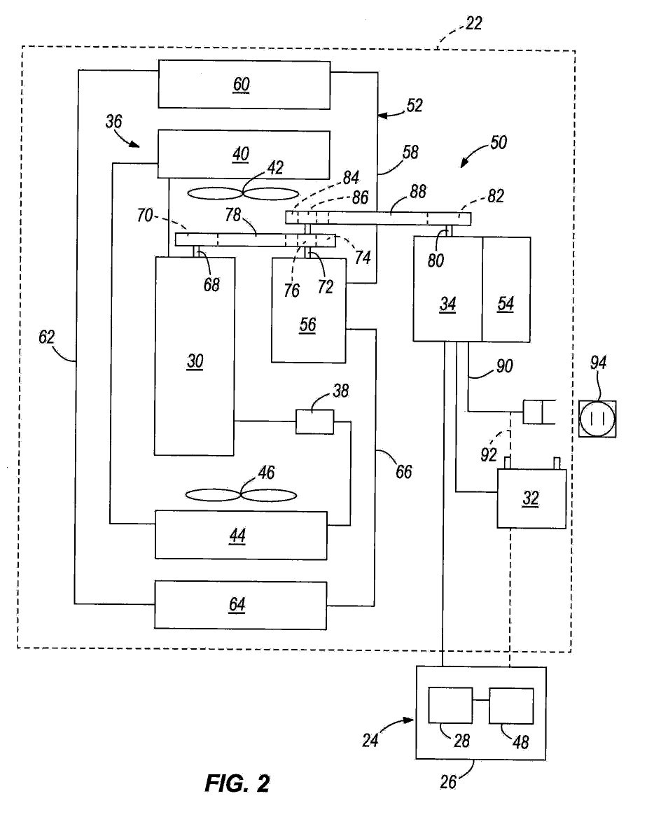

The tractor and trailer unit 10 of FIG. 1 includes a tractor 12 and a trailer 14. The trailer 14 includes cargo space used for shipping goods. The trailer 14 can include a refrigeration system 16 used to control the temperature within the cargo space. The tractor 12 includes a frame 18, a passenger compartment 20, and an engine compartment 22. The tractor 12 also includes an auxiliary power unit (“APU”) 24 coupled to the frame 18 outside of the engine compartment 22. With further reference to FIG. 2, the APU 24 includes a housing 26, a diesel-fueled engine 28 supported within the housing 26, and a generator 48 supported within the housing 26 and driven by the diesel-fueled engine 28.

With further reference to FIG. 2, the tractor 12 includes an engine 30 supported within the engine compartment 22 and configured to power the tractor 12 for movement, a battery 32 supported within the engine compartment 22 and configured to supply power to electrical components of the tractor 12, and an electric motor 34 supported within the engine compartment 22.

The tractor 12 includes an engine cooling system 36 having a circulation pump 38 that pumps engine coolant through a water jacket of the engine 30 to remove heat from the engine 30 and into the coolant. The coolant is then directed to a radiator 40 where a fan 42 directs ambient air across the radiator 40 to remove heat from the coolant. In some embodiments, the fan 42 does not operate to remove heat at the radiator 40, but instead the heat is removed at a downstream heat exchanger 44 that is used to heat the passenger compartment 20. At the heat exchanger 44 a fan 46 directs air across the heat exchanger 44 to remove heat from the coolant. The air from the heat exchanger 44 is then passed into the passenger compartment 20 to control the temperature inside the passenger compartment 20. From the heat exchanger 44, the coolant is drawn back into the pump 38 for recirculation. In some embodiments, both fans 42, 46 can operate together to remove heat from the coolant at both the radiator 40 and the heat exchanger 44. In other embodiments, the pump 38 can also include an electric heater to heat the coolant to warm the engine 30 in cold temperature conditions for improved starting of the engine 30.

The tractor 12 also includes an air conditioning system 50 for cooling the passenger compartment 20. The air conditioning system 50 includes a refrigerant circuit 52 and a control 54. The refrigerant circuit 52 includes a compressor 56 to compress a gaseous refrigerant and direct the compressed refrigerant via a discharge line 58 to a condenser 60 where the refrigerant is cooled. At the condenser 60 the fan 42 directs ambient air across the condenser 60 to remove heat from the refrigerant. Although not shown, the condensed liquid refrigerant can be delivered to a receiver vessel. The condensed liquid refrigerant is routed from the condenser 60 via a liquid line 62 to the evaporator 64. Prior to reaching the evaporator 64, the liquid refrigerant is forced through an expansion valve (not shown), where the liquid refrigerant encounters low pressure, boils, and evaporates thereby converting the liquid refrigerant into a two-phase fluid. The two-phase refrigerant absorbs heat from air being directed through the evaporator 64 by the fan 46. The refrigerant generally leaves the evaporator 64 in a superheated condition and is routed back via a suction line 66 to the compressor 56 for recycling. The cooled air exiting the evaporator 64 is introduced into the passenger compartment 20 by the fan 46 to cool the passenger compartment 20.

The engine 30 includes a rotating output shaft 68 coupled to a pulley 70. The compressor 56 has an input shaft 72 coupled to a pulley 74 through an electromagnetic clutch 76. The electromagnetic clutch 76 is electrically connected to the control 54 to selectively provide a magnetic coupling between the shaft 72 and the pulley 74. In some embodiments, the electromagnetic clutch 76 is a magnetic fluid clutch, a powder clutch, an eddy-current clutch, or a hysteresis clutch. The pulleys 70, 74 are coupled together with a belt 78.

The electric motor 34 includes a rotating output shaft 80 coupled to a pulley 82. The input shaft 72 of the compressor 56 is coupled to a pulley 84 through a sprag clutch 86, also referred to as a free-wheel or unidirectional clutch. The sprag clutch 86 is a free-wheel device having an inner race coupled to the input shaft 72, and an outer race coupled to the pulley 84. The outer race drives the inner race in the direction of operation of the compressor 56 and permits the inner race to over-run in the same direction. The pulleys 82, 84 are coupled together with a belt 88.

The control system 54 is electrically coupled to the fans 42, 46 to control when the fans 42, 46 operate. The control system 54 is also electrically coupled to the electromagnetic clutch 76 to control when the electromagnetic clutch 76 is engaged to allow the transfer of torque from the pulley 74 to the input shaft 72. The battery 32 is electrically connected to the control 54 to selectively provide power to the control 54, the electric motor 34, the electromagnetic clutch 76 and the fans 42, 46. The tractor 12 also includes a power cord 90 electrically connected to the control 54. The control 54 is also electrically connected to the APU 24. In some embodiments, a power cord 92 can be electrically coupled to the battery 32 and the APU 24 can be electrically coupled to the battery 32.

When the engine 30 is running the control 54 engages the electromagnetic clutch 76 and the engine 30 drives the compressor 56 through the output shaft 68, the pulley 70, the belt 78, the engaged electromagnetic clutch 76, the pulley 74, and the input shaft 72. The source of electrical power for the control 54, the fans 42, 46, the electromagnetic clutch 76, and other tractor accessories is provided by the battery 32, which remains charged by an alternator system (not shown) of the tractor 12. When the engine 30 drives the compressor 56, the input shaft 72 rotates, but the belt 88 does not move because the sprag clutch 86 free-wheels such that no torque is transferred from the rotating input shaft 72 to the pulley 84.

When the engine 30 is shut down, for example when the tractor 12 is parked, the control 54 will disengage the electromagnetic clutch 76, wait for the compressor 56 to stop rotating, and start the electric motor 34 to drive the compressor 56 through the output shaft 80, the pulley 82, the belt 88, the pulley 84, the sprag clutch 86, and the input shaft 72. The source of electrical power for the electric motor 34, the control 54, the fans 42, 46, and other tractor accessories can be provided from a number of different sources. When the electric motor 34 drives the compressor 56, the input shaft rotates 72, but the belt 78 does not move because the electromagnetic clutch 76 is disengaged such that no torque is transferred from the input shaft 72 to the pulley 74.

In one construction, the source of electrical power is provided by the battery 32. However, since the engine 30 is no longer running and the alternator no longer charges the battery 32, a separate source of power must be eventually electrically connected to the battery 32 to keep the battery 32 charged. The battery 32 can be connected to and kept charged from an external power source such as an electrical outlet 94 through the power cord 92 or the APU 24. When the external power sources arc used to charge the battery 32, a 12 or 24 Volt transformer (not shown) can be used to provide the proper voltage signal to the battery 32. These external power sources are external to the engine compartment 22 of the tractor 12.

In another construction, the source of electrical power is provided directly from the electrical outlet 94 through the power cord 90 or provided directly from the APU 24. In these situations, the power is used to directly power the control 54, the electric motor 34, and the fans 42, 46 rather than to maintain the charge on the battery 32. When the external power sources are used directly power the tractor accessories, a 12 or 24 Volt transformer (not shown) can be used to provide the proper voltage signal.

When the engine 30 is re-started while the electric motor 34 is driving the compressor 56, the control 54 will stop the electric motor 34, wait for the compressor 56 to stop rotating, and engage the electromagnetic clutch 76 to drive the compressor 56 through the output shaft 68, the pulley 70, the belt 78, the pulley 74, the electromagnetic clutch 76, and the input shaft 72.

Various features and advantages of the invention are set forth in the following claims.

What is claimed is:

1. A tractor unit for pulling a trailer unit, the tractor unit comprising:
a frame;
a passenger compartment supported by the frame;
an engine compartment supported by the frame;
an engine disposed within the engine compartment;
a battery supported by the frame;
an electric motor supported by the frame;
a refrigerant circuit including a compressor operable to compress a refrigerant and an evaporator operable to allow the refrigerant to absorb heat from an air stream directed into the passenger compartment to cool the passenger compartment;
a first clutch coupled between the engine and the compressor, the first clutch operable to selectively engage to drive the compressor with the engine when the engine is running;
a second clutch coupled between the electric motor and the compressor, the second clutch operable to selectively engage to drive the compressor with the electric motor when the engine is not running, wherein only one of the first and second clutches is engaged to operate the compressor when the engine is one of running and not running; and
wherein when the second clutch is engaged the electric motor is powered by one of a power source external to the engine compartment and the battery in electrical communication with a power source external to the engine compartment.

2. The tractor unit of claim 1, wherein the power source external to the engine compartment is one of an electrical outlet and an auxiliary power unit coupled to the frame.

3. The tractor unit of claim 2, further comprising a power cord electrically coupled to the electric motor, and wherein the power source external to the engine compartment is the electrical outlet electrically coupled to the electric motor through the power cord.

4. The tractor unit of claim 3, wherein the power cord is electrically coupled to the electric motor through the battery, and wherein the power source external to the engine compartment is the electrical outlet electrically coupled to the electric motor through the power cord and the battery.

5. The tractor unit of claim 2, wherein the auxiliary power unit is electrically coupled to the electric motor, and wherein the power source external to the engine compartment is the auxiliary power unit.

6. The tractor unit of claim 5, wherein the auxiliary power unit is electrically coupled to the electric motor through the battery, and wherein the power source external to the engine compartment is the auxiliary power unit electrically coupled to the electric motor through the battery.

7. The tractor unit of claim 2, wherein the power source external to the engine compartment is the auxiliary power unit, and the auxiliary power unit includes a generator powered by a diesel-fired engine.

8. An air conditioning system for a tractor unit used to pull a trailer unit, the tractor including a frame, a passenger compartment supported by the frame, an engine compartment supported by the frame, an engine disposed within the engine compartment, and a battery supported by the frame, the air conditioning system comprising:
an electric motor configured to be supported by the frame;
a refrigerant circuit including a compressor operable to compress a refrigerant and an evaporator operable to allow the refrigerant to absorb heat from an air stream directed into the passenger compartment to cool the passenger compartment;
a first clutch configured to selectively engage to drive the compressor with the engine when the engine is running;
a second clutch coupled between the electric motor and the compressor, the second clutch configured to selectively engage to drive the compressor with the electric motor when the engine is not running, wherein only one of the first and second clutches is engaged to operate the compressor when the engine is one of running and not running; and
wherein when the second clutch is engaged the electric motor is powered by one of a power source external to the engine compartment and the battery in electrical communication with a power source external to the engine compartment.

9. The air conditioning system of claim 8, wherein the power source external to the engine compartment is one of an electrical outlet and an auxiliary power unit configured to be coupled to the frame.

10. The tractor unit of claim 9, further comprising a power cord electrically coupled to the electric motor, and wherein the power source external to the engine compartment is the electrical outlet electrically coupled to the electric motor through the power cord.

11. The tractor unit of claim 10, wherein the power cord is electrically coupled to the electric motor through the battery, and wherein the power source external to the engine compartment is the electrical outlet electrically coupled to the electric motor through the power cord and the battery.

12. The tractor unit of claim 9, wherein the auxiliary power unit is electrically coupled to the electric motor, and wherein the power source external to the engine compartment is the auxiliary power unit.

13. The tractor unit of claim 12, wherein the auxiliary power unit is electrically coupled to the electric motor through the battery, and wherein the power source external to the engine compartment is the auxiliary power unit electrically coupled to the electric motor through the battery.

14. The air conditioning system of claim 9, wherein the power source external to the engine compartment is the auxiliary power unit, and the auxiliary power unit includes a generator powered by a diesel-fired engine.

15. A method of operating an air conditioning system for a tractor unit used to pull a trailer unit, the tractor including a frame, a passenger compartment supported by the frame, an engine compartment supported by the frame, an engine disposed within the engine compartment, and a battery supported by the frame, the method comprising:
compressing a refrigerant in a refrigeration circuit with a compressor;
absorbing heat from an air stream with the refrigerant in an evaporator;
directing the air stream into the passenger compartment to cool the passenger compartment;
engaging a first clutch;
driving the compressor through the first engaged clutch with the engine when the engine is running;
disengaging the first clutch;
engaging a second clutch;
driving the compressor through the second engaged clutch with the electric motor when the engine is not running; and
powering the electric motor when the second clutch is engaged by one of a power source external to the engine compartment and the battery in electrical communication with a power source external to the engine compartment

16. The air conditioning system of claim 15, further comprising powering the electric motor when the second clutch is engaged by one of an electrical outlet and an auxiliary power unit configured to be coupled to the frame.

17. The tractor unit of claim 16, further comprising powering the electric motor with the electrical outlet through a power cord.

18. The tractor unit of claim 17, further comprising powering the electric motor with the electrical outlet through a power cord and the battery.

19. The tractor unit of claim 16, further comprising powering the electric motor by the auxiliary power unit.

20. The tractor unit of claim 19, further comprising powering the electric motor by the auxiliary power unit through the battery.
